(19) United States
(12) Patent Application Publication
(10) Pub. No.: US 2026/0110375 A1
(43) Pub. Date: Apr. 23, 2026

(54) EGG-SHAPED PIPE THAT IS EASY TO CONNECT AND DISCONNECT

(71) Applicant: SHINWOO IND. CO., LTD., Gimpo-si (KR)

(72) Inventor: Juwhan KIM, Seoul (KR)

(73) Assignee: SHINWOO IND. CO., LTD., Gimpo-si (KR)

(21) Appl. No.: 19/048,805

(22) Filed: Feb. 7, 2025

(30) Foreign Application Priority Data
Oct. 22, 2024 (KR) 10-2024-0144726

(51) Int. Cl. F16L 9/00

(52) U.S. Cl. CPC F16L 9/006

(57) ABSTRACT

Provided is an egg-shaped pipe that is easy to connect and disconnect and is directed to providing an egg-shaped pipe that is easy to connect and disconnect, ensuring that step differences do not occur in a flow path hole during connection (joining) of the egg-shaped pipe, thereby facilitating the smooth flow of fluid and sediment without any residue of sediment in the flow path hole. The present invention is configured such that a joining portion made of a circular tubular body is integrally molded at both ends of a main body portion, which is made of an egg-shaped tubular body. Through the joining portion made of the circular tubular body, a plurality of egg-shaped pipes is connected (joined), and the configuration ensures that no step differences occur between the flow path hole of one egg-shaped pipe and the flow path hole of another egg-shaped pipe connected thereto.

### CROSS-REFERENCE TO RELATED APPLICATIONS

This application claims the priority of Korean Patent Application No. 10-2024-0144726 filed on Oct. 22, 2024, in the Korean Intellectual Property Office, the disclosure of which is incorporated herein by reference.

### BACKGROUND

### Field

The present invention relates to an egg-shaped pipe that is easy to connect and disconnect, and to an egg-shaped pipe in which a joining portion made of a circular tubular body is integrally molded at both ends of a main body portion made of an egg-shaped tubular body, so that a plurality of egg-shaped tubular bodies can be easily connected without generating step differences in a flow path hole by a circular pipe connection device that is already in use.

### Description of the Related Art

Typically used water supply and drainage pipes are mainly formed as circular tubular bodies (tubular bodies of cylindrical pipe structure) with a circular cross-section using synthetic resin. The circular pipe formed with a circular cross-section as described above has a curved lower portion, which allows fluid to flow smoothly. However, since the flow speed is slow, it not only fails to move fluids that need to be quickly discharged, such as household wastewater, but also leaves sediment behind, causing odor problems.

In addition, the pressure strength capable of supporting in response to the pressure applied from the upper portion of the circular pipe is weak, and after a certain period of time, cracks or breakages occur in the circular pipe, leading to leakage of the fluid to the outside.

To resolve the issues of the circular tubular body as described above, an egg-shaped pipe has been used, in which the upper portion of the tubular body is formed wider and the lower portion is formed narrower, thereby shaping the overall cross-section into an egg shape.

The egg-shaped pipe increases the flow rate of the passing fluid (household wastewater), enabling it to move (discharge) quickly, and at the same time, it has the advantage of being able to withstand the load pressure from the upper portion. However, since the egg-shaped pipe is joined (connected) using a connection pipe formed and shaped of an egg-shaped pipe, there is a lack of expertise in joining the egg-shaped pipe. As a result, efficient connection (joining) is not achieved, leading to leakage due to the reduced water-tightness and sealing of the connection part, and the joining portion is not stably maintained.

In addition, due to the egg-shaped cross-sectional structure of the egg-shaped pipe, it is difficult to install and connect the egg-shaped pipe straight. Furthermore, as the length increases, the twisting or tilting phenomenon occurs, and when multiple units are connected (joined), the fluid cannot be moved efficiently, resulting in a decrease in transport capacity. Additionally, the strength of the tubular body also decreases.

In particular, due to the characteristics of its cross-sectional shape, the egg-shaped pipe requires the development and use of a separate joining device. However, the joining device for connecting (joining) the egg-shaped pipe is limited to use with the egg-shaped pipe, leading to a decrease in efficiency.

Additionally, the egg-shaped pipe is not standardized in terms of its cross-sectional structure, and each manufacturer provides a different egg-shaped cross-sectional structure. As a result, the egg-shaped pipe joining device used varies depending on the installed egg-shaped pipe. This leads to an increase in installation costs and a decrease in workability on-site. Due to these issues, the use of egg-shaped pipes is not being widely implemented in actual field situations.

Various research and development efforts have been made to address the problems associated with the connection (joining) of the egg-shaped pipe, but most of these efforts focus on the connection device for the egg-shaped pipe. There is currently no configuration related to changing the shape of the egg-shaped pipe itself, as seen in the present invention.

### DOCUMENT OF RELATED ART

### Patent Document

(Patent Document 1) Korean Utility Model Application Laid-Open No. 20-1998-0020241 (Jul. 15, 1998)
(Patent Document 2) Korean Patent No. 10-2116480 (May 22, 2020)
(Patent Document 3) Korean Utility Model Application Laid-Open No. 20-1998-0020240 (Jul. 15, 1998)
(Patent Document 4) Korean Utility Model Application Laid-Open No. 20-1998-0020243 (Jul. 15, 1998)

### SUMMARY

The present invention is directed to providing an egg-shaped pipe that is easy to connect and disconnect, ensuring that step differences do not occur in a flow path hole during connection (joining) of the egg-shaped pipe, thereby facilitating the smooth flow of fluid and sediment without any residue of sediment in the flow path hole.

The present invention is directed to providing an egg-shaped pipe that is easy to connect and disconnect, and improves water-tightness and sealing when connecting (joining) the egg-shaped pipes, thereby achieving easy connection and disconnection.

The present invention is directed to providing an egg-shaped pipe that is easy to connect and disconnect, while maintaining the characteristics of the egg-shaped pipe and to providing an egg-shaped pipe that facilitate mutual connection and disconnection, thereby improving the overall strength.

The present invention is directed to providing an egg-shaped pipe that is easy to connect and disconnect, which can be mutually connected (joined) by the previously known circular pipe connection device.

The present invention is configured such that a joining portion made of a circular tubular body is integrally molded at both ends of a main body portion, which is made of an egg-shaped tubular body. Through the joining portion made of the circular tubular body, a plurality of egg-shaped pipes is connected (joined), and the configuration ensures that no step differences occur between the flow path hole of one egg-shaped pipe and the flow path hole of another egg-shaped pipe connected thereto, thereby enabling smooth flow of fluid and sediment.

The present invention is configured such that the flow path holes of the main body portion, connection portion, and joining portion are continuously connected without step differences, thereby ensuring smooth flow of fluid regardless of rainfall.

The present invention ensures that even when a plurality of egg-shaped pipes is connected (joined), the flow path holes are continuously connected without step differences. As a result, no sediment residue or fluid stagnation occurs within the connection part between the egg-shaped pipes, thereby enabling smooth flow of fluid and sediment.

In particular, the present invention is configured such that joining portions made of circular tubular bodies are installed at both ends of the egg-shaped tubular body. This allows for the quick and accurate connection (joining) of adjacent egg-shaped pipes using the known circular pipe connection device. Additionally, since the lowest part of the flow path in the connection part of the egg-shaped pipe is continuously connected without step differences, the characteristics of the egg-shaped pipe are effectively maintained.

The present invention allows a plurality of egg-shaped pipes to be connected (joined) by joining portions made of circular tubular bodies, thereby enabling the related components of the known circular pipe connection device (such as packing, joint pipes, etc.) to be applied without modification.

In addition, the present invention allows a plurality of egg-shaped pipes to be connected (joined) by the joining portion made of a circular tubular body and the known circular pipe connection device. This not only ensures that the connection state can be clearly verified, but also stabilizes the joining portion, improving water-tightness and sealing performance.

That is, the present invention enhances the overall strength through the connection of the main body portion, connection portion, and joining portion, which have different cross-sectional structures. It also allows a plurality of egg-shaped pipes to be connected (joined) using the known circular pipe connection device. This makes it easy to verify the degree of coupling of the joining portion within the circular pipe connection device. As a result, the water-tightness and fastening condition of the interconnected egg-shaped pipes are firmly maintained, preventing separation between the interconnected egg-shaped pipes even if shaking occurs.

Additionally, the present invention, when the joining portion of the circular tubular body is connected (joined) by the conventional circular pipe connection device equipped with supporting means, allows the main body portion made of the egg-shaped tubular body to be disposed and connected in the correct position without any additional operations. This improves overall construction efficiency and enhances the performance of the egg-shaped pipe itself.

The present invention allows a plurality of egg-shaped pipes to be connected (joined) by the joining portion made of a circular tubular body and the known circular pipe connection device. This improves the construction efficiency for connecting the egg-shaped pipes and enhances the sealing and water-tightness between the egg-shaped pipes. In particular, the present invention does not require specialized or skilled techniques, unlike the connection (joining) of conventional egg-shaped pipes. As a result, it reduces the work time and improves workability on-site, while also achieving a reduction in economic costs.

In addition, the egg-shaped pipe according to the present invention is configured such that joining portions made of circular tubular bodies are integrally molded at both ends of the main body portion made of an egg-shaped tubular body. Compared to the conventional egg-shaped pipe made only of an egg-shaped tubular body, this configuration offers many benefits, including improved resistance to load pressure or lateral pressure, i.e., enhanced overall strength.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an exemplified view illustrating the configuration of an egg-shaped pipe according to the present invention;

FIG. 2 is an exemplified view illustrating the internal configuration of the egg-shaped pipe according to the present invention;

FIG. 3 is another exemplified view illustrating the internal structure of the egg-shaped pipe according to the present invention;

FIG. 4 is an exemplified view illustrating the egg-shaped cross-sectional structure of a main body portion according to the present invention;

FIG. 5 is an exemplified view illustrating the connection of the main body portion, connection portion, and joining portion according to the present invention;

FIG. 6 is an exemplified view illustrating the cross-sectional configuration of a-a, b-b, c-c, and d-d in FIG. 1;

FIG. 7 is an exemplified view illustrating the cross-sectional configuration of a′-a′, b′-b′, c′-c′, and d′-d′ in FIG. 1; and

FIG. 8 is an exemplified view illustrating the connection (joining) state of the egg-shaped pipe according to the present invention.

### DETAILED DESCRIPTION OF THE EMBODIMENT

The present invention is configured such that joining portions made of circular tubular bodies are integrally molded at both ends of a main body portion made of an egg-shaped tubular body. Through the joining portions made of circular tubular bodies, a plurality of egg-shaped pipes is connected (joined), ensuring that a lowest part of a flow path in a flow path hole of one egg-shaped pipe and a lowest part of a flow path in a flow path hole of another egg-shaped pipe connected thereto are connected (joined) without step differences.

The egg-shaped pipe according to the present invention may be configured such that joining portions made of circular tubular bodies are integrally molded at both ends of the main body portion made of an egg-shaped tubular body.

Additionally, the egg-shaped pipe according to the present invention may be configured such that joining portions made of circular tubular bodies are integrally molded at both ends of the main body portion made of an egg-shaped tubular body, with the joining portions being molded together as a single unit.

Hereinafter, the present invention will be described in detail based on the exemplified views in the attached drawings.

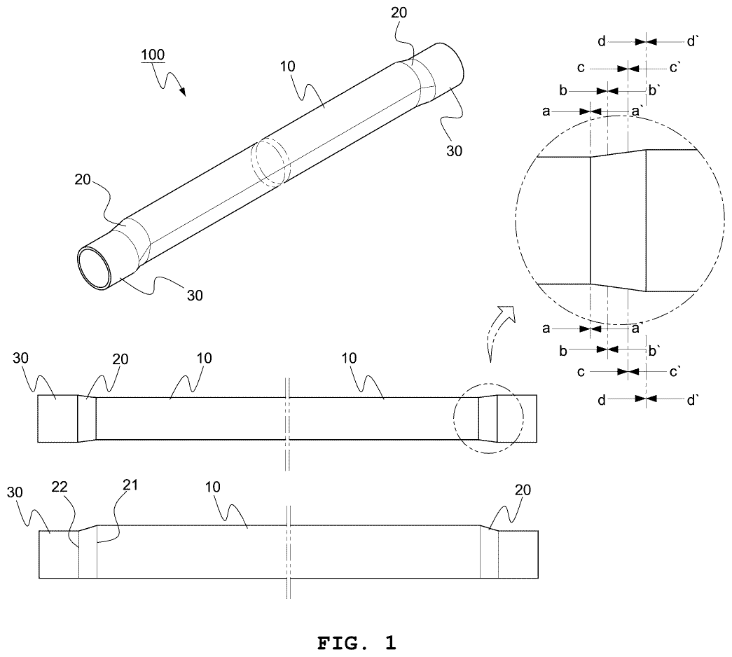

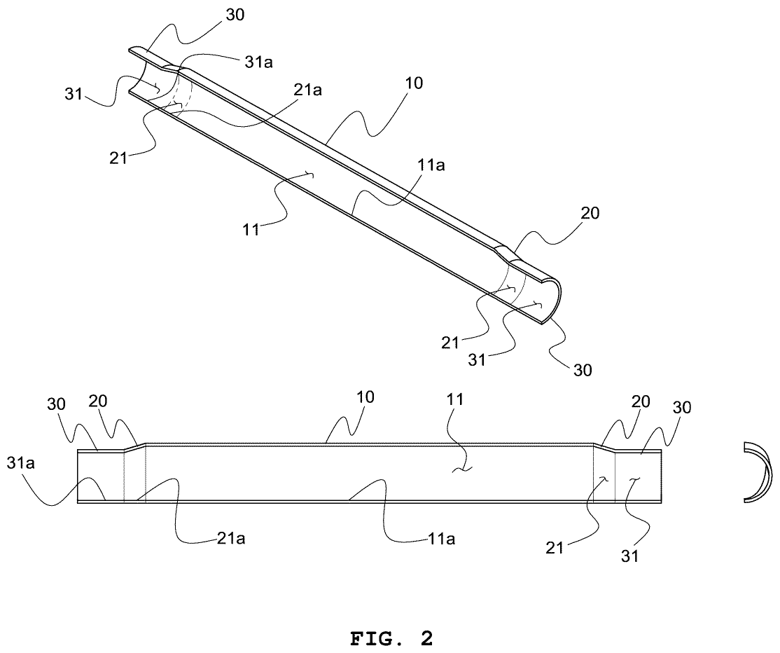

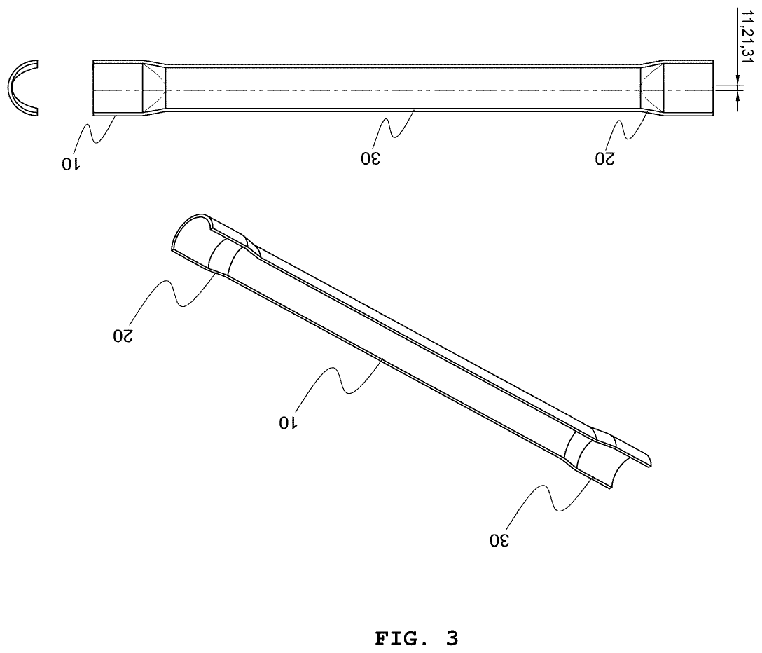

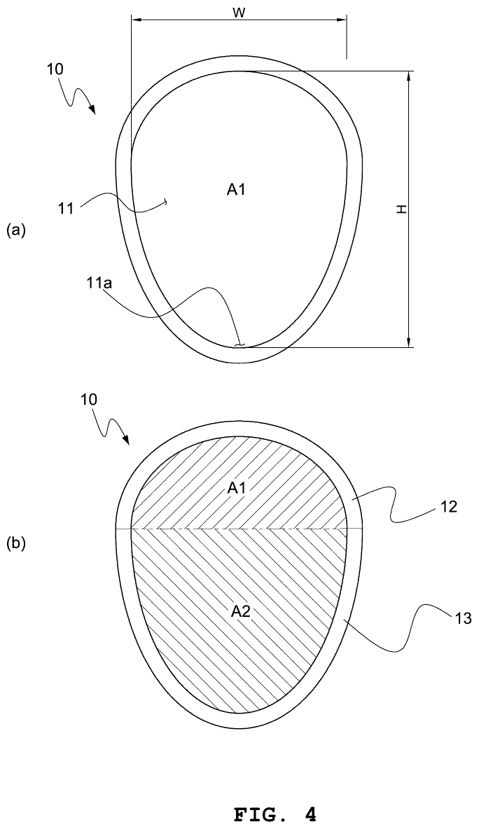

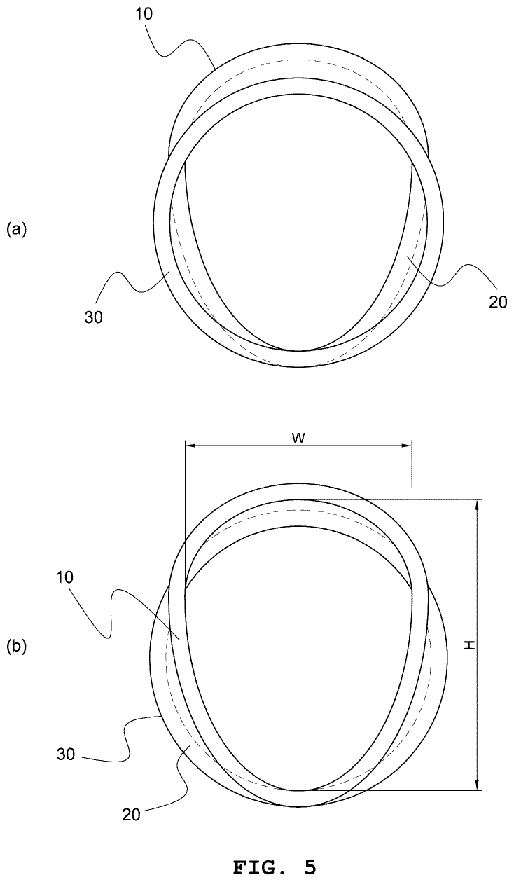

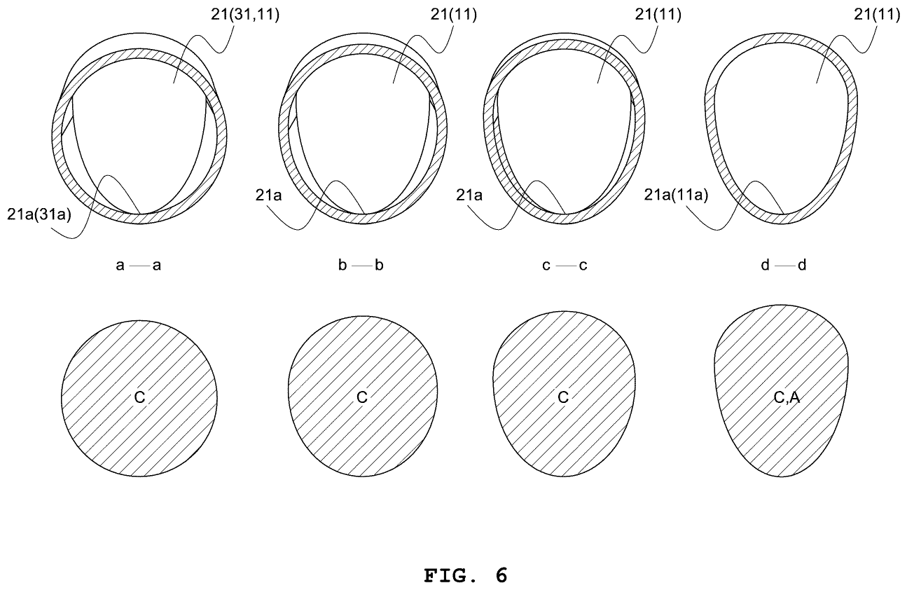

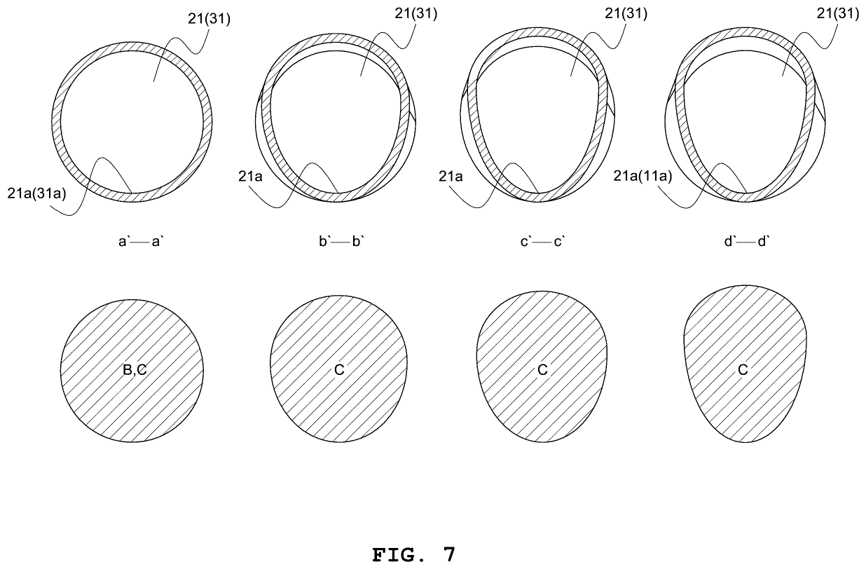

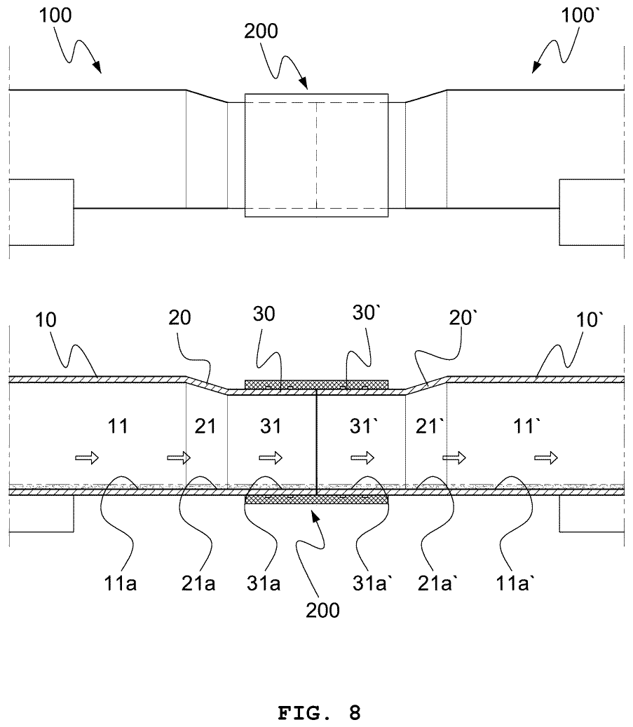

FIG. 1 is an exemplified view illustrating the configuration of an egg-shaped pipe according to the present invention, FIG. 2 is an exemplified view illustrating the internal configuration of the egg-shaped pipe according to the present invention, FIG. 3 is another exemplified view illustrating the internal structure of the egg-shaped pipe according to the present invention, FIG. 4 is an exemplified view illustrating the egg-shaped cross-sectional structure of a main body portion according to the present invention, FIG. 5 is an exemplified view illustrating the connection of the main body portion, connection portion, and joining portion according to the present invention, FIG. 6 is an exemplified view illustrating the cross-sectional configuration of a-a, b-b, c-c, and d-d in FIG. 1, FIG. 7 is an exemplified view illustrating the cross-sectional configuration of a′-a′, b′-b′, c′-c′, and d′-d′ in FIG. 1, and FIG. 8 is an exemplified view illustrating the connection (joining) state of the egg-shaped pipe according to the present invention.

A egg-shaped pipe 100 according to the present invention includes: a main body portion 10 made of an egg-shaped tubular body; a joining portion 30 made of a circular tubular body, which is integrally formed with a predetermined length at both ends of the main body portion; and a connection portion 20 that integrally connects the main body portion 10 and the joining portion 30. The main body portion 10, connection portion 20, and joining portion 30 are configured such that flow path holes 11, 21, and 31 are continuously connected without height deviation (step differences).

The egg-shaped pipe 100 according to the present invention has the flow path holes 11, 21, and 31 that are mutually communicated to form a single flow path hole.

The main body portion 10 is made of a conventional egg-shaped pipe structure having an egg-shaped cross-section, with the upper portion being wider and the lower portion narrower. That is, the main body portion 10 is made of the same configuration as a conventional egg-shaped pipe, consisting of an egg-shaped tubular body with the upper portion wider and the lower portion narrower.

The main body portion 10, as illustrated in FIG. 4, has a flow path hole 11 formed in an egg-shaped cross-section (A, the vertical cross-section of the flow path hole). Based on a maximum width W in the horizontal direction, the main body portion 10 consists of an upper main body 12 having an upper cross-section A1 and a lower main body 13 having a lower cross-section A2, integrated into a single structure.

That is, the upper cross-section A1 is disposed on the upper side, based on the maximum width W of the flow path hole 11 in the horizontal direction, and the lower cross-section A2 is disposed on the lower side, based on the maximum width W of the flow path hole 11 in the horizontal direction. In this case, the upper main body 12, lower main body 13, upper cross-section A1, and lower cross-section A2 are distinguished for the purpose of describing the present invention. However, the upper main body 12, lower main body 13, upper cross-section A1, and lower cross-section A2 are not separately configured but are integrated to form the single main body portion 10 and the egg-shaped cross-section A.

In addition, the egg-shaped cross-section structure illustrated in FIG. 4 of the present invention is one example, and the egg-shaped cross-section structure of the present invention is not limited thereto.

The joining portion 30 is designed to allow the egg-shaped pipe according to the present invention to be connected to another egg-shaped pipe by the known circular pipe connection device. As illustrated in FIG. 7, the flow path hole 31 is configured to have a circular cross-section (B, the vertical cross-section of the flow path hole). That is, the joining portion 30 is made of a circular tubular body (tubular body of cylindrical pipe structure).

The joining portion 30 may be formed such that the circular cross-section B of the flow path hole 31 has approximately 0.8 (A) to 1.2 (A) relative to the egg-shaped cross-section A of the flow path hole 11 of the main body portion.

The ratio between the circular cross-section of the flow path hole of the joining portion and the egg-shaped cross-section of the flow path hole of the main body portion is designed to ensure that, even when the main body portion made of an egg-shaped tubular body and the joining portion made of a circular tubular body are connected (joined), the flow of fluid occurs without stagnation within the flow path hole, allowing for smooth fluid flow.

When the circular cross-section of the flow path hole of the joining portion is configured to be less than 0.8 (A), the overall flow capacity decreases, and when high rainfall or a sudden increase in flow rate occurs, blockage or stagnation of the fluid flow may happen. On the other hand, when it exceeds 1.2 (A), the diameter of the joining portion made of the circular tubular body increases, leading to reduced construction efficiency and productivity. Therefore, it is preferable to achieve the ratio within an appropriate range.

In addition, it is preferable for the circular cross-section B of the flow path hole 31 to have a size of approximately 0.95 (A) to 1.2 (A) relative to the egg-shaped cross-section A of the flow path hole 11 of the main body portion. More preferably, it may be formed to have the same cross-sectional area as the egg-shaped cross-section A of the flow path hole 11 of the main body portion. When such an area ratio is achieved, the circular cross-section B of the flow path hole 31 and the egg-shaped cross-section A of the flow path hole 11 of the main body portion are formed with nearly identical areas, ensuring that the overall flow capacity of the egg-shaped pipe remains constant.

Additionally, when the circular cross-section B of the flow path hole 31 relative to the egg-shaped cross-section A of the flow path hole 11 of the main body portion is in the range of approximately 0.95 (A) to 1.1 (A), the joining portion 30 having the circular cross-section B may be formed to have a radius r as defined by [Equation 1] below. That is, when the radius r is maintained as described above, the circular cross-section B of the flow path hole 31 will be within the range of approximately 0.95 (A) to 1.1 (A) relative to the egg-shaped cross-section A of the flow path hole 11 of the main body portion.

$$Radius ( r ) = \sqrt{\frac{A}{π}} \qquad [ Equation 1 ]$$

In addition, the joining portion 30 may be formed such that the circumference (perimeter) of the circular tubular body matches the circumference of the main body portion 10 made of the egg-shaped tubular body. When the joining portion 30 and the main body portion 10 have the same circumference, as described above, the molding process of the joining portion 30, made of the circular tubular body, at the end of the main body portion 10, made of the egg-shaped tubular body, becomes easier.

Additionally, it is preferable for the joining portion 30 to be formed to have the circular cross-section B of the flow path hole 31 that is in the range of approximately 0.8 (A) to 1.2 (A), particularly from approximately 0.95 (A) to 1.1 (A), relative to the egg-shaped cross-section A of the flow path hole 11 of the main body portion while ensuring that the circumference (perimeter) of the circular tubular body matches the circumference of the main body portion 10 made of the egg-shaped tubular body.

The connection portion 20, as illustrated in FIG. 1, has one end 22 integrally connected to the main body portion 10 and the other end 23 integrally connected to the joining portion 30, and is provided with the flow path hole 21 therein.

Additionally, the flow path hole 21 of the connection portion is configured such that as illustrated in FIG. 6, the end 22 connected to the main body portion is provided with the same egg-shaped cross-section A as the flow path hole 11 of the main body portion, and the other end 23 connected to the joining portion, as illustrated in FIG. 7, is provided with the same circular cross-section B as the flow path hole 31 of the joining portion. Further, the flow path hole 21 of the connection portion is provided with a variable cross-section C, in which, from the end 22 to the other end 23, the maximum width W of the egg-shaped cross-section A gradually increases to match a diameter R of the circular cross-section B, while a maximum height H of the egg-shaped cross-section A gradually decreases to match the diameter R of the circular cross-section B.

That is, the variable cross-section C is configured to have an egg-shaped cross-sectional shaped structure at any points, and have the same size as the circular cross-section B of the joining portion at the other end connected to the joining portion, and configured such that from the end 22 to the other end 23, the egg-shaped cross-section A gradually transforms into the circular cross-section B shape.

The egg-shaped pipe 100 according to the present invention, configured as described above, does not have the main body portion 10, connection portion 20, and joining portion 30 as separate components to be integrally connected or coupled. Instead, as illustrated in FIG. 1 to FIG. 3 and FIG. 5, the lower inner surfaces of the flow path holes 11, 21, and 31 provided in each portion are continuously connected without step differences. The ends of the main body portion 10 are molded so that the connection portion 20 and the joining portion 30 are integrally provided with the main body portion 10.

That is, the egg-shaped pipe 100 according to the present invention is formed such that flow path lowest parts 11a, 21a, and 31a of the flow path holes 11, 21, and 31 respectively provided in the main body portion 10, connection portion 20, and joining portion 30 are continuously connected without height deviation. Therefore, when the plurality of egg-shaped pipes 100 are installed consecutively, fluid stagnation and sediment residue are prevented from occurring not only in the flow path hole within the egg-shaped pipe, but also within the connection part of the egg-shaped pipe.

The flow path lowest parts 11a, 21a, and 31a correspond to the lowest parts of the flow path holes, i.e., the lower portions through which fluid flows within the flow path holes 11,21, and 31, when the plurality of egg-shaped pipes 10 according to the present invention are installed consecutively. As an example, the flow path lowest part may correspond to the lowest part of the flow path hole, or may be a portion corresponding to a height from the lowest part of the flow path hole to a portion where fluid flows in the flow path hole at low flow depth of rainfall of 5 mm or less.

Additionally, as described above, when the main body portion 10 and the joining portion 30 are integrated by the connection portion 20 so that the egg-shaped cross-section A of the flow path hole 11 of the main body portion and the circular cross-section B of the flow path hole 31 are made identical, the tubular body thickness remains consistent for the main body portion and the joining portion, or the main body portion, the connection portion and the main body portion. As a result, no strength degradation occurs in the egg-shaped pipe 100 according to the present invention.

In addition, when the tubular body thickness is made identical, the flow path lowest parts of the main body portion, connection portion, and joining portion will align without height deviation. As a result, a separate work may be omitted to ensure the alignment of the flow path lowest parts during the molding process of the connection portion and joining portion with the main body portion.

Additionally, in the present invention as configured above, due to the variable cross-section C of the connection portion, an expanding flow path is formed in the direction from the lower main body 13 provided at one end of the main body portion towards the joining portion 30, as illustrated in FIG. 3 and FIG. 6, where the flow path gradually expands. On the other hand, a contracting flow path is formed in the direction from the joining portion 30 towards the lower main body 130 provided at the other end of the main body portion, as illustrated in FIG. 3 and FIG. 7, where the flow path gradually contracts. As a result, according to the Venturi effect, no flow rate changes occur from the main body portion to the joining portion. That is, the egg-shaped pipe according to the present invention, compared to an egg-shaped pipe made solely of the main body portion, ensures that no loss in overall flow capacity occurs.

Additionally, in the present invention, the main body portion 10 with the egg-shaped cross-section A and the joining portion 30 with the circular cross-section B are connected through the variable cross-section C of the connection portion. This configuration ensures that the flow path lowest parts 11a, 21a, and 31a of the main body portion 10, connection portion 20, and joining portion 30 are continuously connected without height deviation (step differences). Considering the precipitation characteristics of South Korea (where the number of days with rainfall of 5 mm or less, corresponding to low flow depth, occurs approximately 69%, and the number of days with rainfall of 15 mm or less, corresponding to moderate flow depth, occurs approximately 82%, with low and moderate flow depths accounting for most of the rainfall), the egg-shaped pipe according to the present invention, compared to a conventional egg-shaped pipe made solely of an egg-shaped tubular body, has the characteristics of no significant difference or superiority in the overall flow rate and flow capacity at low flow depths and moderate flow depths.

Additionally, the egg-shaped pipe according to the present invention is continuously configured such that the flow path holes of the main body portion, connection portion, and joining portion are all connected in a straight line without height deviation (step differences). Further, in the joining portion, a tapered contracting flow path is provided within the connection portion in the direction towards the lower main body provided at the other end of the main body portion. As a result, the flow rate of the fluid within the main body portion increases, preventing the attachment of foreign substances to the inner walls of the flow path hole in the main body portion.

Additionally, the egg-shaped pipe according to the present invention is continuously configured such that the flow path holes of the main body portion, connection portion, and joining portion are all connected in a straight line without height deviation (step differences). An expanding flow path is formed, gradually expanding the flow path in the direction from the lower main body provided at one end of the main body portion towards the joining portion. This results in the generation of vortices within the flow path hole of the joining portion, which leads to the effect of preventing the accumulation of foreign substances or sediment on the inner walls of the flow path hole. As a result, the fluid flow from the main body portion to the joining portion becomes smooth, ensuring efficient and unobstructed fluid movement.

FIG. 8 is an exemplified view illustrating the connection (joining) state of the egg-shaped pipe according to the present invention.

The egg-shaped pipe according to the present invention, when a plurality of pipes are connected (joined), ensures that, as illustrated in FIG. 8, the flow path lowest parts 11a, 21a, and 31a of the flow path holes 11, 21, and 31 respectively provided in the main body portion 10, connection portion 20, and joining portion 30 of one egg-shaped pipe 100 are connected in a straight line without step differences to the flow path lowest parts 11a′, 21a′, and 31a′ of the flow path holes 11′, 21′, and 31′ provided in the joining portion 30′, connection portion 20′, and main body portion 10′ of another egg-shaped pipe 100′. This not only ensures smooth fluid flow but also prevents the sediment residue and fluid stagnation within the egg-shaped pipe itself as well as the connection part of the egg-shaped pipe. As a result, the characteristics of the egg-shaped pipe, in accordance with its original purpose and effects, are maintained as it is.

In addition, the plurality of egg-shaped pipes according to the present invention are connected by the joining portion made of a circular tubular body. Therefore, a circular pipe connection device 200 that is already in use may be directly applied, allowing the connection work for the plurality of egg-shaped pipes 100 and 100′ to be performed.

In particular, when the size of the joining portion made of a circular tubular body is formed to be the same as the conventional circular pipe size, the conventional circular pipe connection device may be directly applied without modification. This enables the assembly of the egg-shaped pipe according to the present invention to proceed more smoothly.

Additionally, in the present invention, when the plurality of egg-shaped pipes is connected and installed in a straight line, expanding and contracting flow paths are repeatedly provided around the connection part of the egg-shaped pipe, ensuring that the overall fluid flow remains smooth.

The egg-shaped pipe according to the present invention, configured as described above, is formed by extruding the egg-shaped tubular body to form the main body portion. Both ends of the main body portion are inserted into a molding device, and the connection portion and the joining portion made of a circular tubular body are integrally molded at both ends.

For example, the egg-shaped pipe according to the present invention may be formed such that the main body portion of a synthetic resin material that is made of the egg-shaped tubular body is extruded. The ends of the extruded main body portion are heated and softened, and a hydrostatic chamber is installed on the outer side of the softened end of the egg-shaped pipe. The joining portion is molded and cooled under hydraulic pressure within the hydraulic chamber, allowing the connection portion and the joining portion made of a circular tubular body to be integrally molded at both ends of the main body portion made of an egg-shaped tubular body.

Additionally, the egg-shaped pipe according to the present invention, configured as described above, includes all structures for forming the egg-shaped pipe, such as single-walled pipe structure, double-walled pipe structure, and triple-walled pipe structure.

The present invention is not limited to the specific embodiment described above, various modifications can be made by any person skilled in the art to which the present invention pertains without departing from the subject matter of the present invention as claimed in the claims, and the modifications are within the scope defined by the claims.

In addition, the terms used to describe the present invention are used only for the purpose of distinguishing one constituent element from another constituent element and assisting in understanding the present invention, and the constituent elements of the present invention should not be limited by the terms.

What is claimed is:

1. An egg-shaped pipe that is easy to connect and disconnect, the egg-shaped pipe comprising:
a main body portion made of an egg-shaped tubular body;
a joining portion made of a circular tubular body molded integrally at both ends of the main body portion,
wherein a plurality of egg-shaped pipes is connected (joined) through the joining portion made of the circular tubular body, so that a flow path lowest part in a flow path hole of one egg-shaped pipe and a flow path lowest part in a flow path hole of another egg-shaped pipe connected thereto are connected (joined) without step differences.

2. The egg-shaped pipe of claim 1, wherein the egg-shaped pipe includes:
the main body portion made of the egg-shaped tubular body; the joining portion made of the circular tubular body and formed integrally with a predetermined length at both ends of the main body portion; and
a connection portion integrally connecting the main body portion and the joining portion, and
wherein the main body portion, the connection portion, and the joining portion are configured such that the flow path lowest parts of the flow path holes are continuously connected without step differences.

3. The egg-shaped pipe of claim 2, wherein the joining portion is formed such that a circumference of the circular tubular body matches a circumference of the main body portion made of the egg-shaped tubular body.

4. The egg-shaped pipe of claim 2, wherein the main body portion has the flow path hole as an egg-shaped cross-section (A), the joining portion has the flow path hole as a circular cross-section (B), and the connection portion has a variable cross-section (C) in which a maximum width (W) of the egg-shaped cross-section (A) gradually increases to match a diameter (R) of the circular cross-section (B), and a maximum height (H) of the egg-shaped cross-section (A) gradually decreases to match a diameter (R) of the circular cross-section (B).

5. The egg-shaped pipe of claim 4 wherein the circular cross-section (B) of the flow path hole of the joining portion is formed to have 0.8 (A) to 1.2 (A) relative to the egg-shaped cross-section (A) of the flow path hole of the main body portion.

6. The egg-shaped pipe of claim 4, wherein the circular cross-section (B) of the flow path hole of the joining portion has 0.95 (A) to 1.1 (A) relative to the egg-shaped cross-section (A) of the flow path hole of the main body portion (11), and the circular cross-section (B) of the joining portion is formed to have a radius (r) according to [Equation 1] below
$$Radius ( r ) = \sqrt{\frac{A}{π}} . \qquad [ Equation 1 ]$$

7. The egg-shaped pipe of claim 4, wherein the circular cross-section (B) of the flow path hole of the joining portion has a range of 0.95 (A) to 1.1 (A) relative to the egg-shaped cross-section (A) of the flow path hole (11) of the main body portion, and
wherein the circumference of the circular tubular body is formed to match the circumference of the main body portion made of the egg-shaped tubular body.
